(19) United States
(12) Patent Application Publication
(10) Pub. No.: US 2004/0253353 A1
(43) Pub. Date: Dec. 16, 2004

(54) Steam-free deodorization process

(76) Inventors: Dick Copeland, Omaha, NE (US); Roger Koch, Bellevue, NE (US); Stan Loft, San Diego, CA (US)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 10/463,181

(22) Filed: Jun. 16, 2003

(51) Int. Cl. C11B 1/00

(52) U.S. Cl. 426/417

(57) ABSTRACT

This invention relates to methods for treating edible oils to remove objectionable impurities. More particularly, this invention relates to methods for deodorizing edible oils at reduced pressure in the presence of non-condensible inert gas, wherein a non-steam vacuum source maintains the operating pressure, and wherein the non-condensible gas is recovered and recycled for use in one or more deodorizing steps.

### FIELD OF THE INVENTION

This invention relates to methods for treating edible oils to remove objectionable impurities. More particularly, this invention relates to methods for deodorizing edible oils at reduced pressure in the presence of non-condensible inert gas, wherein a non-steam vacuum source maintains the operating pressure, and wherein the non-condensible gas is recovered and recycled for use in one or more deodorizing steps.

### BACKGROUND OF THE INVENTION

Deodorization is usually the final step in producing edible oils and fats from plant and animal sources. Vegetable oils such as soybean oil typically contain volatile impurities that can impart objectionable odor and taste. Impurities that can impart objectionable properties to vegetable oil include pesticides, free fatty acids, aldehydes, ketones, alcohols, hydrocarbons, tocopherols, sterols, and phytosterols. Although the concentration of each type of impurity generally is quite low, often being less than 1 percent, the impurities must be removed in amounts sufficient to produce deodorized oil having preferred taste and odor characteristics. For example, free fatty acid content should be reduced to a level of less than about 0.15 percent to obtain edible oil having desired properties. Following their removal, several impurities, especially fatty acids, tocopherols, and sterols, can be recovered and profitably sold.

Methods of deodorizing oils and fats by distilling away volatile impurities have been practiced for many years, having evolved from simple forms to more complex modem methods that apply principles of physical chemistry and chemical engineering. Early methods employing simple heating to volatilize odorous materials gave way to improved methods that added steam during heating to hasten vaporization and subsequent removal of impurities. For example, mid-nineteenth century European techniques achieved deodorization of fats by blowing steam through heated oils. Later methods utilized superheated steam. Later still, reduced pressure in conjunction with steam blowing produced fats having improved flavor and odor for use in margarines. About 1900, David Wesson in the United States designed an improved steam-vacuum deodorizer that eliminated air contamination and thereby produced oils of unmatched quality up to that time.

Modem commercial deodorization generally involves a steam stripping process wherein steam is contacted with oil in a distillation apparatus operating at low pressure and a temperature sufficient to vaporize objectionable volatile impurities at the operating pressure. This process, commonly known as vacuum-steam deodorization, relies upon volatility differences between the oil and the objectionable impurities to drive the relatively more volatile objectionable impurities away from the relatively less volatile oil.

In a typical vacuum-steam deodorizing process, vegetable oil is introduced into a distillation apparatus having a plurality of vertically spaced trays, commonly termed stripping trays. As an alternative or in addition to the stripping trays, the distillation apparatus may contain one or more regions filled with a packing material and/or may contain one or more regions through which oil falls vertically in thin films. The purpose of the stripping trays and/or regions of packing material and/or thin film regions is to maximize the surface area of the oil, and hence maximize volatilization of impurities.

Deodorization occurs under high vacuum conditions to prevent oxidative degradation during processing. Within each stripping tray and/or region of packing material and/or thin film region, oil is subjected to heat and a flow of stripping steam to hasten removal of the vaporizing impurities. For economical operation, the stripping is carried out at as high a vacuum as practically possible. Vacuum conditions of 6 mm Hg or less are typical and are generally obtained with multi-stage steam ejectors. The oil remains exposed to heat for as short a time as possible in order to minimize detrimental effects that can occur at elevated temperatures. Volatile impurities are boiled off and combine with the stripping steam to form distillation vapors that are rapidly removed to ensure maximum continued volatilization of impurities from the oil. The distillation vapors are usually collected and condensed to form one or more distillates that can be disposed of or processed further to recover valuable materials. The deodorized oil is subsequently cooled to minimize susceptibility to oxidative degradation and is then made available for sale or further processing.

The theoretical aspects of steam stripping are governed by Raoult's law and Dalton's law. Accordingly, the amount of each impurity removed is directly proportional to its vapor pressure, which in turn is directly proportional to the deodorization temperature and the amount of steam added. Thus, increasing the temperature and/or stripping steam rate can increase the removal of impurities. However, increasing temperature conditions increasingly promote thermal degradation of oil, including formation of undesirable trans fatty acids. The need to avoid such thermal degradation thereby places an effective upper limit on the operating temperature.

Stripping steam usage rate is also effectively limited. Increased use of stripping steam produces greater oil losses due to increased oil hydrolysis, emulsion formation, and mechanical entrainment of oil in the stripping steam. Increasing the stripping steam rate also increases the volume of distillation vapors that must be removed. Distillation vapors are drawn out by and combine with steam introduced downstream by the multi-stage ejector vacuum equipment. The amount of steam required to operate the vacuumizing ejectors is generally several times the amount of stripping steam. Ejector steam employed to generate high vacuum becomes contaminated by the vaporized impurities and other volatilized organic components carried within the distillation vapor. All of the combined flow of contaminated ejector steam and distillation vapors must be condensed and then treated for disposal or to recover valuable organic components.

Thus, steam and cooling water requirements for steam deodorization are substantial. Although steam is relatively inexpensive and is widely utilized in most commercial oil deodorization operations to strip volatile impurities from the oil and to generate high vacuum conditions, there remains a need for methods of deodorizing oils in an energy efficient manner.

Several deodorization methods have been proposed wherein stripping steam is replaced by a non-condensible inert gas. For example, U.S. Pat. No. 5,091,116 teaches a method for deodorizing edible oils that comprises continuously contacting heated oil with nitrogen under at least substantially atmospheric pressure conditions. However, because impurity removal rate is inversely proportional to the system pressure, this process operating at atmospheric pressure (760 mm Hg) or greater would require a higher deodorizing temperature, longer residence time, or both to achieve the same impurity removal rate obtained in conventional deodorization processes operating at less than 10 mm Hg.

In an alternative method, U.S. Pat. Nos. 5,241,092 and 5,374,751 disclose processes for deodorizing edible oils that comprise contacting heated oil under high vacuum with a non-condensible inert gas, wherein the non-condensible inert gas is preheated prior to being introduced and/or the amount of non-condensible inert gas introduced is substantially less than the theoretically required amount for deodorizing based on a comparison to steam. However, the disclosed processes use steam ejector equipment to generate high vacuum conditions, which leads to water contamination of the non-condensible inert gas, severely limiting or even precluding its recycle.

Thus, none of the above methods employing non-condensible inert gas in deodorization of edible oils has proved satisfactory. Consequently, further improvements in methods for deodorizing edible oils have been sought. The present invention relates to improved processes having advantages over those previously disclosed. The methods of the invention employ non-condensible inert gas in high vacuum deodorization processes, wherein one or more non-steam vacuum sources maintains the operating pressure. Use of non-steam vacuum sources eliminates water contamination, allowing the non-condensible inert gas to be readily and inexpensively recycled for use in deodorization. The processes of the invention allow a major portion of the non-condensible inert gas utilized in deodorizing to be recycled, and thus are much less expensive and more efficient than prior methods.

### SUMMARY OF THE INVENTION

One aspect of the present invention relates to methods for deodorizing edible oils using non-condensible inert gas as a stripping medium.

Another aspect of the present invention relates to methods for deodorizing edible oils that use one or more non-steam vacuum sources to maintain reduced pressure.

Yet another aspect of the invention relates to methods for deodorizing edible oils that allow non-condensible inert gas used as stripping medium to be readily and inexpensively recycled for use in deodorization.

One embodiment of the invention is a process for treating edible oil that comprises introducing edible oil containing objectionable impurities into a heating zone operating at a pressure of less than about 10 mm Hg and at a temperature of greater than about 375° F.; deodorizing the edible oil in the presence of non-condensible inert gas for a time sufficient to produce a vapor phase comprising a substantial fraction of the objectionable impurities, other vaporized components of the edible oil, and non-condensible inert gas, leaving a deodorized edible oil; recovering the non-condensible inert gas from the vapor phase; and recycling the recovered non-condensible inert gas for use in deodorizing step; wherein a non-steam vacuum source is in communication with and maintains the operating pressure of the heating zone.

Another embodiment of the invention is a process for treating edible oil that comprises introducing edible oil containing objectionable impurities into a heating zone operating at a pressure of less than about 10 mm Hg and at a temperature of greater than about 375° F.; deodorizing the edible oil in the presence of non-condensible inert gas for a time sufficient to produce a vapor phase comprising a substantial fraction of the objectionable impurities, other vaporized components of the edible oil, and non-condensible inert gas, leaving a deodorized edible oil; introducing the vapor phase into one or more cooling zones for a time sufficient to produce one or more condensates, leaving an impure non-condensible inert gas; filtering the impure non-condensible inert gas to produce a recovered non-condensible inert gas; and recycling the recovered non-condensible inert gas for use in deodorizing step; wherein a non-steam vacuum source is in communication with and maintains the operating pressure of the heating zone.

Yet another embodiment of the invention is a process for treating edible oil that comprises introducing edible oil containing objectionable impurities into a first heating zone operating at a pressure of less than about 10 mm Hg and at a first temperature of greater than about 375° F.; deodorizing the edible oil in the presence of non-condensible inert gas for a time sufficient to produce a first vapor phase comprising a substantial fraction of the objectionable impurities, other vaporized components of the edible oil, and non-condensible inert gas, leaving a liquid residue containing a remaining portion of objectionable impurities; introducing the liquid residue into a second heating zone operating at a pressure of less than about 10 mm Hg and at a second temperature of greater than about 375° F.; deodorizing the liquid residue in the presence of non-condensible inert gas for a time sufficient to produce a second vapor phase comprising a substantial fraction of the remaining portion of objectionable impurities, other vaporized components of the liquid residue, and non-condensible inert gas, leaving a deodorized edible oil; recovering the non-condensible inert gas from one or both of the first and second vapor phases; and recycling the recovered non-condensible inert gas for use in one or both of the deodorizing steps; wherein a non-steam vacuum source is in communication with and maintains the operating pressure of the first and second heating zones.

Still another embodiment of the present invention is a process for treating edible oils that comprises introducing edible oil containing objectionable impurities into a first heating zone operating at a pressure of less than about 10 mm Hg and at a first temperature of greater than about 375° F.; deodorizing the edible oil in the presence of non-condensible inert gas for a time sufficient to produce a first vapor phase comprising a substantial fraction of the objectionable impurities, other vaporized components of the edible oil, and non-condensible inert gas, leaving a liquid residue containing a remaining portion of objectionable impurities; introducing the liquid residue into a second heating zone operating at a pressure of less than about 10 mm Hg and at a second temperature of greater than about 375° F.; deodorizing the liquid residue in the presence of non-condensible inert gas for a time sufficient to produce a second vapor phase comprising a substantial fraction of the remaining portion of objectionable impurities, other vaporized components of the liquid residue, and non-condensible inert gas, leaving a deodorized edible oil; introducing one or both of the first and second vapor phases into one or more cooling zones for a time sufficient to produce one or more condensates, leaving an impure non-condensible inert gas; filtering the impure non-condensible inert gas to produce a recovered non-condensible inert gas; and recycling the recovered non-condensible inert gas for use in one or both of the deodorizing steps; wherein a non-steam vacuum source is in communication with and maintains the operating pressure of the first and second heating zones.

These and other aspects of the invention will become apparent in light of the detailed description below.

As used herein, the term “non-condensible inert gas” means any one or mixture of inert gases that do not condense at the operating temperature and pressure. Non-condensible inert gases include but are not limited to nitrogen, carbon dioxide, argon, helium, hydrogen, and mixtures thereof.

As used herein, the term “steam-free” means that steam does not come into direct contact with oil or vaporized distillate. However, steam may be utilized to supply heat indirectly, as by use of a heat exchanger.

As used herein, the term “edible oil” means any one or mixture of oils and/or fats derived from vegetable and/or animal sources. The term “vegetable” includes but is not limited to soybean, corn, cottonseed, palm, peanut, rapeseed, safflower, sunflower, sesame, rice bran, coconut, canola, and mixtures thereof. The term “animal” includes but is not limited to fish, mammal, reptile, and mixtures thereof.

### BRIEF DESCRIPTION OF THE DRAWINGS

FIG. 1 illustrates one process suitable for carrying out the methods of the present invention.

### DESCRIPTION OF A PREFERRED EMBODIMENT

All methods of the invention can be conducted as batch, semi-continuous, or continuous processes. The improved processes of the invention deodorize edible oils. Many sources of edible oils are suitable for use in the invention, including but not limited to crude oil; oil that has been subjected to at least one of the steps of degumming, neutralizing, dewaxing, decoloring, bleaching, winterizing, hydrogenating, filtering, and deaerating; alkali-refined oil; organic acid-refined oil (disclosed in U.S. Pat. No. 6,172,248, herein incorporated by reference); physically refined oil; and mixtures thereof. Organic acid-refined soybean oil is particularly suited to processes of the invention.

The composition of edible oil will vary depending upon the oil type and pre-deodorization refining history. Among other impurities, organic acid-refined soybean oil generally contains from about 0.1 to about 0.3 percent by weight free fatty acids, from about 14 to about 18 percent by weight tocopherols, and from about 23 to about 33 percent by weight sterols.

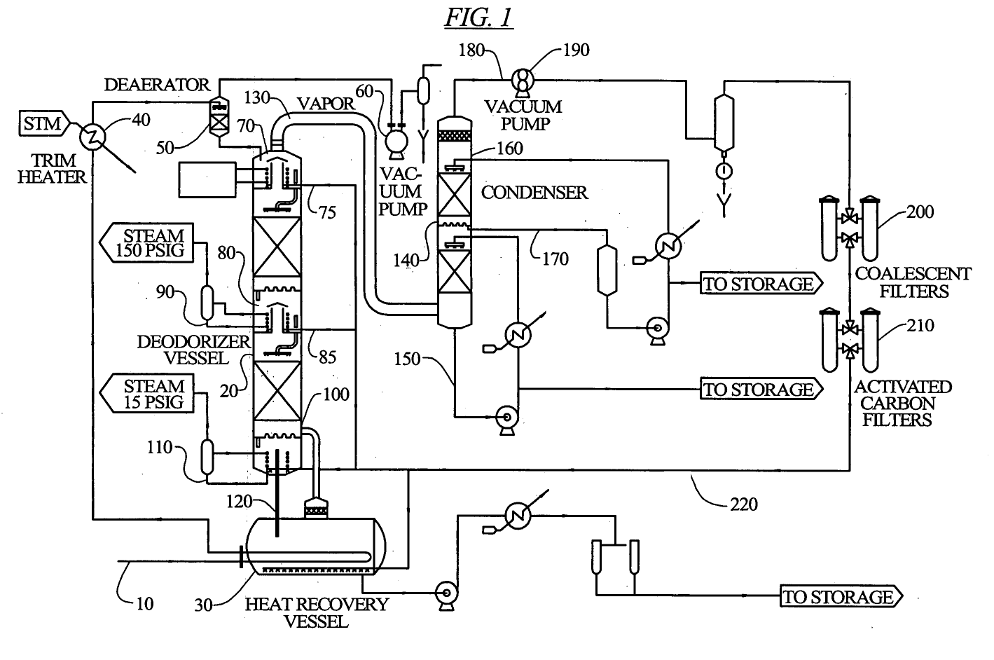

FIG. 1 illustrates a continuous process suitable for carrying out the methods of the invention. As illustrated in FIG. 1, one method of the invention for deodorizing edible oils generally entails introducing an edible oil 10 into the a first heating zone 70 of a deodorizing tower 20 that has at least two heating zones and operates at a pressure of less than about 10 mm Hg. Deodorizing tower 20 typically has a length to diameter ratio of at least about 3, and is preferably constructed of 316 stainless steel to combat the corrosive properties of fatty acids at high temperatures. Preferably, the plurality of heating zones within deodorizing tower 20 are spaced apart vertically, although other orientations are viable.

Optionally, but preferably, edible oil 10 is preheated prior to being introduced into first heating zone 70. Preheating can occur via any convenient method at any point outside or inside the tower, but preferably occurs by indirect contact with deodorized oil upon passing through a deodorized oil heat recovery vessel 30. Use of a deodorized oil heat recovery vessel 30 allows maximum recovery of heat from discharged deodorized oil and at the same time serves to cool the deodorized oil to a certain extent prior to its being discharged. Although indirect preheating methods can be located within the tower, utilizing preheating methods outside the tower offers the greatest flexibility, since a variety of pressures can be utilized in such preheating methods.

The edible oil 10 optionally can be provided heat input by passing it through a trim heater 40. The edible oil 10 optionally can also be deaerated by passing it through a non-steam vacuum deaerator 50. Non-steam vacuum deaerator 50 may be equipped with indirect heating means to provide additional heat input to the edible oil. Non-steam vacuum deaerator 50 may also be provided with means for injecting or otherwise introducing non-condensible inert gas into the edible oil to ensure maximize removal of air from the edible oil 10 prior to deodorization. Vacuum can be supplied to non-steam vacuum deaerator 50 by any suitable non-steam method, including but not limited to use of a mechanical vacuum pump such as a multistage centrifugal pump, a water- or oil-sealed rotary pump, a liquid ring vacuum pump, or a dry-vacuum reciprocating pump. Preferably, vacuum is supplied to non-steam vacuum deaerator 50 by use of a liquid ring vacuum pump.

Edible oil 10 is introduced into first heating zone by any convenient method, such as by pumping or by gravity. The rate at which edible oil 10 is introduced into first heating zone 70 will vary based on the dimensions of deodorizing tower 20 and/or first heating zone 70.

Deodorizing tower 20 is maintained under vacuum by one or more non-steam vacuum sources 190. Suitable non-steam vacuum sources 190 include but are not limited to mechanical vacuum pumps such as multistage centrifugal pumps, water- or oil-sealed rotary pumps, liquid ring vacuum pumps, or dry-vacuum reciprocating pumps. Deodorizing tower 20 generally operates at a pressure of less than about 10 mm Hg, and preferably operates at a pressure of 6 mm Hg or less.

First heating zone 70 operates at a temperature of greater than about 375° F., and preferably greater than about 475° F. Most preferably, first heating zone 70 operates at a temperature of from about 480° to about 525° F. First heating zone 70 can be equipped with one or more stripping trays. Alternatively, or in addition, first heating zone 70 can contain packing material and/or can contain one or more thin film regions. Suitable packing material includes but is not limited to stainless steel plates, mesh or wire, or may consist other suitable inert materials such as porcelain or ceramic. A preferred packing material comprises a plurality of sawtooth-profile stainless steel plates spaced closely apart and perforated by a plurality of holes.

In the first heating zone 70, edible oil 10 is contacted with non-condensible inert gas 75. Preferably, the non-condensible inert gas 75 is substantially water-free nitrogen having a purity of greater than about 98 percent. A suitable nitrogen source includes but is not limited to a Praxair PSA Nitrogen System, available from Praxair Technology, Inc., Danbury, Conn. The non-condensible inert gas 75 is introduced at a rate sufficient to strip volatile impurities from edible oil 10. Although the usage rate of non-condensible inert gas 75 will vary based on the type and flow rate of oil, the oil pre-deodorization history, and the dimensions of deodorizing tower 20, when the non-condensible inert gas 75 is nitrogen, it is generally introduced at a rate of from about 0.1 to about 10 liters per minute. Preferably, nitrogen is introduced at a rate of from about 0.5 to about 3 liters per minute, which equates generally to a rate of from about 0.2 to about 20 pounds per hundred pounds of oil to be deodorized. Because the present invention utilizes non-steam vacuum sources, the allowable flow rate of incondensible inert gas is not limited by any concerns about usage rate and/or contamination of ejector steam, as is the case with prior technologies. However, using a greater amount of non-condensible inert gas 75 than is required to strip the desired amount of impurities can lead to greater expense in cooling the resulting vaporized distillates.

Non-condensible gas 75 may be introduced by any convenient method, including injecting or sparging it within the body of edible oil 10 in first heating zone 70. The flow of non-condensible inert gas 75 may be regulated by a valve or other similar methods. To enhance the stripping action, the non-condensible inert gas 75 may be heated prior to being introduced into the edible oil 10. Increasing the temperature of the non-condensible inert gas 75 decreases the size of bubbles formed upon its introduction into the edible oil 10, which in turn improves mass transfer of impurities from the edible oil 10 into the vapor phase by increasing the gas-liquid interfacial area for the given volume of non-condensible inert gas 75 employed. The mass transfer rate can be further enhanced by introducing the non-condensible inert gas 75 through small orifice openings and/or at sonic velocity to promote further reduction in gas bubble size.

In order to minimize thermal degradation, edible oil 10 is exposed to heat in first heating zone 70 for the minimum time required to drive off a substantial fraction of the objectionable impurities contained in edible oil 10. Generally, edible oil 10 is exposed to heat in first heating zone 70 for a time of less than about 45 minutes, and preferably less than about 30 minutes.

During deodorization in first heating zone 70, a first vapor phase is formed, leaving a liquid residue containing a remaining portion of objectionable impurities. The first vapor phase comprises a substantial fraction of the objectionable impurities, non-condensible inert gas 75, and other vaporized components of the edible oil 10, which include but are not limited to free fatty acids, sterols, and tocopherols. The action of non-steam vacuum source 190 draws the first vapor phase to the top of deodorizing tower 20 and into vapor conduit 130, whereupon it can be processed to recover one or more condensate fractions enriched in one or more of free fatty acids, sterols, and tocopherols. The liquid residue flows downwardly and is introduced in second heating zone 80. Deodorization in first heating zone 70 generally produces a first vapor phase the comprises about 85 percent or more of the amount of free fatty acids contained in edible oil 10, about 25 percent or more of the amount of tocopherols contained in edible oil 10, and about 15 percent or more of the amount of sterols contained in edible oil 10.

Second heating zone 80 operates at a temperature of greater than about 375° F., and preferably greater than about 425° F. The operating temperature of second heating zone 80 can be the same, lower than, or greater than the operating temperature of first heating zone 70. Most preferably, second heating zone 80 operates at a temperature of from about 425° to about 470° F. Like the first heating zone 70, second heating zone 80 can be equipped with one or more stripping trays and/or can contain packing material and/or can contain one or more thin film regions.

In the second heating zone 80, the liquid residue from deodorization of edible oil 10 in first heating zone 70 is contacted with non-condensible inert gas 85. Preferably, the non-condensible inert gas 85 is substantially water-free nitrogen having a purity of greater than about 98 percent. Non-condensible inert gas 85 can be introduced into second heating zone 80 by any convenient method that can be the same or different than the method used to introduce non-condensible inert gas 75 into first heating zone 70. Non-condensible inert gas 85 can be supplied from the same or different source as is used to supply non-condensible inert gas 75, and can be the same or different in composition and flow rate compared to non-condensible inert gas 75.

The non-condensible inert gas 85 is introduced at a rate sufficient to strip a substantial fraction of the remaining portion of objectionable impurities from the liquid residue from deodorization of edible oil 10 in first heating zone 70. Although the usage rate of non-condensible inert gas 85 will vary based on the type and flow rate of such liquid residue, as well as the dimensions of deodorizing tower 20, when the non-condensible inert gas 85 is nitrogen, it is generally introduced at a rate of from about 0.1 to about 10 liters per minute. Preferably, nitrogen is introduced at a rate of from about 0.5 to about 3 liters per minute, which equates generally to a rate of from about 0.2 to about 20 pounds per hundred pounds of oil to be deodorized. Again, because the present invention utilizes non-steam vacuum sources, the allowable flow rate of incondensible inert gas is not limited by any concerns about usage rate and/or contamination of ejector steam, as is the case with prior technologies. However, using a greater amount of non-condensible inert gas 85 than is required to strip the desired amount of impurities can lead to greater expense in cooling the resulting vaporized distillates.

Non-condensible gas 85 may be introduced by any convenient method, including injecting or sparging it within the body of liquid residue in second heating zone 80. The flow of non-condensible inert gas 85 may be regulated by a valve or other similar methods. To enhance the stripping action, the non-condensible inert gas 85 may be heated prior to being introduced into the liquid residue. Increasing the temperature of the non-condensible inert gas 85 decreases bubble size, thereby improving mass transfer of impurities by increasing the gas-liquid interfacial area. The mass transfer rate can be further enhanced by introducing the non-condensible inert gas 85 through small orifice openings and/or at sonic velocity to promote further reduction in gas bubble size.

In order to minimize thermal degradation, the liquid residue from deodorization of edible oil 10 in first heating zone 70 is exposed to heat in second heating zone 80 for the minimum time required to drive off a substantial fraction of the remaining portion of objectionable impurities contained in the liquid residue. Generally, the liquid residue is exposed to heat in second heating zone 80 for a time of less than about 45 minutes, and preferably less than about 30 minutes.

During deodorization in second heating zone 80, a second vapor phase is formed, leaving a deodorized edible oil. The second vapor phase comprises a substantial fraction of the remaining portion of objectionable impurities, non-condensible inert gas 85, and other vaporized components of the liquid residue, which include but are not limited to free fatty acids, sterols, and tocopherols. The action of non-steam vacuum source 190 draws the second vapor phase to the top of deodorizing tower 20 and into vapor conduit 130, whereupon it can be processed to recover one or more condensate fractions enriched in one or more of free fatty acids, sterols, and tocopherols. Optionally, but preferably, the second vapor phase combines with the first vapor phase to form a vaporized distillate. The deodorized oil flows downwardly into a collection zone 100 located at the bottom of deodorizing tower 20, whereupon it can be subsequently cooled, and then preferably maintained in an oxygen-free environment, such as provided by nitrogen blanketing. The deodorized oil has better quality than deodorized oil obtained from conventional steam deodorization because it does not contain steam hydrolysis products.

Optionally, but preferably, collection zone 100 is equipped with a heat recovery unit 110. Preferably, heat recovery unit 110 is in thermal contact with the deodorized oil and comprises a heat exchange unit that communicates in a loop with a flash vessel into which is fed condenser water from other refinery operations. Deodorized oil in collection zone 100 indirectly heats the condenser water recirculating through the heat recovery unit 110, ideally vaporizing the condenser water to form 15 psig steam.

Optionally, but preferably, second heating zone 80 is equipped with a heat recovery unit 90. Preferably, heat recovery unit 90 is in thermal contact with the liquid residue in second heating zone 80, and comprises a heat exchange unit that communicates in a loop with a flash vessel into which is fed condenser water from other refinery operations. Liquid residue in second heating zone 80 indirectly heats the condenser water recirculating through the heat recovery unit 90, ideally vaporizing the condenser water to form 150 psig steam.

One or both of the first and second vapor phases is collected and processed to recover non-condensible inert gas. Generally, one or both of the first and second vapor phases is passed through a condenser to form one or more condensates, leaving an impure non-condensible inert gas that can be filtered and recycled. Preferably, the first and second vapor phases combine in vapor conduit 130 to form a vaporized distillate and are drawn by the action of the non-steam vacuum source 190 into a condensing unit. Preferably, the condensing unit contains at least two cooling zones that can operate at the same or different temperatures.

In a preferred condensing mode, the vaporized distillate formed from the combination of the first and second vapor phases is introduced into a first cooling zone 140 of a condensing unit operating at a pressure of less than about 10 mm Hg and in communication with non-steam vacuum source 190. The condensing unit can be any piece of equipment capable of operating at reduced pressure and elevated temperature and having at least two condensing zones. Preferably, the condensing unit is a condenser or scrubber fabricated or adapted to contain at least two condensing zones.

First cooling zone 140 operates at a temperature less than the boiling point of tocopherols and sterols at the operating pressure but greater than the boiling point of fatty acids at the operating pressure. Table 1 indicates the boiling point of tocopherols and sterols at several reduced pressures.

TABLE 1

| | Tocopherols | |
|---|---|---|
| Pressure (mmHg) | boiling point (° F.) | Sterols boiling point (° F.) |
| 1 | 444 | 464 |
| 2 | 468 | 473 |
| 3 | 486 | 500 |
| 4 | 500 | 518 |

At each of the pressures listed in Table 1, the boiling point of fatty acids is less than 200° F. Generally, the first cooling zone 140 operates at a temperature of from about 330° to about 430° F. Preferably, the first cooling zone 140 operates at a temperature of from about 3550 to about 405° F., and most preferably operates at a temperature of from about 370° to about 390° F.

Within the first cooling zone 140, a portion of the vaporized distillate is condensed to produce a first condensate 150 enriched in sterols and tocopherols, which can be recovered and profitably sold or processed further. Remaining uncondensed vaporized distillate flows to a second cooling zone 160 for further processing. Generally, at least a portion of the first condensate 150 is recirculated into the first cooling zone 140 through a spray nozzle or other arrangement as a mist or spray countercurrent to the flow direction of the vaporized distillate to provide direct cooling upon contact with vaporized distillate as it is drawn upward by the action of non-steam vacuum source 190. Optionally, the vaporized distillate passes through a packing material in the first cooling zone 140. The type of packing is selected based on factors well known to those in the art, including mechanical strength, resistance to corrosion, cost, capacity, and efficiency, and may be the same or different from packing material optionally utilized in deodorizer tower 20.

Remaining uncondensed vaporized distillate exiting the first cooling zone 140 enters a second cooling zone 160, whereupon a portion is condensed to produce a second condensate 170 enriched in fatty acids, leaving an impure non-condensible inert gas 180. The second cooling zone 160 operates at a temperature less than the boiling point of fatty acids at the operating pressure. Generally, the second cooling zone 160 operates at a temperature of from about 100 to about 170° F. Preferably, the second cooling zone 160 operates at a temperature of from about 125 to about 145° F, and most preferably at a temperature of from about 130 to about 140° F. The second cooling zone 160 can have the same configuration and/or be equipped with the same or different packing material as the first cooling zone 140. Generally, at least a portion of the second condensate is recirculated into the second cooling zone 160 through a spray nozzle or other arrangement as a mist or spray countercurrent to the flow direction of the remaining uncondensed vaporized residue as it is drawn upward by action of the non-steam vacuum source 190. The second cooling zone 160 can have the same configuration and/or be equipped with the same or different packing material as the first cooling zone 140. Once produced, the second condensate 170 can be processed further by various known methods to isolate a sterol and/or a tocopherol fraction.

The action of non-steam vacuum source 190 draws the impure non-condensible inert gas 180 out of second cooling zone 160 and then urges it through one or both of a coalescent filter 200 and an activated carbon filter 210. Preferably, coalescent filter 200 is a Parker-Hannifin coalescent filter. Filtering of the impure non-condensible inert gas removes remaining uncondensed impurities and produces a recovered non-condensible inert gas 220, which is then recycled for use deodorizing. Alternatively, the impure non-condensible inert gas 180 may be introduced into a PSA Nitrogen System for purification to form a recovered non-condensible inert gas 220. Generally, the amount of recycled recovered non-condensible inert gas 220 is at least about 85 percent of the combined amount of non-condensible inert gases 75 and 85 used in the deodorizing steps. Preferably, the amount of recycled recovered non-condensible inert gas 220 is greater than about 90 percent of the amount of non-condensible inert gas used in deodorizing.

All documents, e.g., patents, journal articles, and textbooks, cited above or below are hereby incorporated by reference in their entirety.

One skilled in the art will recognize that modifications may be made in the present invention without deviating from the spirit or scope of the invention. The invention is illustrated further by the following examples, which are not to be construed as limiting the invention in spirit or scope to the specific procedures or compositions described therein.

### EXAMPLE 1

15.875 kilograms of organic acid refined soybean oil containing 0.3 percent free fatty acids, 0.137 percent tocopherols, and 0.273 percent sterols and having a Lovibond color of 70Y/5.7R was fed at a rate of 10 kg./hr into a deodorizer containing structured packing and operating at an inlet pressure of 1 mm Hg and a temperature of 520° F. Nitrogen was introduced at a rate of 1.2 liters/minute, equating to a rate of 0.836 lbs./100 lbs. oil, or 2.53 standard cubic feet (scf)/100 lbs. oil. The oil was deodorized in the presence of nitrogen for a time of about 90 minutes, producing 15.373 kilograms of deodorized oil (96.8 percent yield) containing 0.019 percent free fatty acids, 0.095 percent tocopherols, and 0.223 percent sterols and having a Lovibond color of 10Y/1.0R, and produced 96.8 grams of a distillate that contained 53.3 percent free fatty acids, 4.2 percent tocopherols, and 5.2 percent sterols.

### EXAMPLE 2

6.804 kilograms of organic acid refined soybean oil containing 0.3 percent free fatty acids, 0.137 percent tocopherols, and 0.273 percent sterols and having a Lovibond color of 70Y/5.7R was fed at a rate of 10 kg./hr into a deodorizer containing structured packing and operating at an inlet pressure of 1 mm Hg and a temperature of 480° F. Nitrogen was introduced at a rate of 1.2 liters/minute, equating to a rate of 0.836 lbs./100 lbs. oil, or 2.53 standard cubic feet (scf)/100 lbs. oil. The oil was deodorized in the presence of nitrogen for a time of about 90 minutes, producing 6.62 kilograms of deodorized oil (97.3 percent yield) containing 0.026 percent free fatty acids, 0.120 percent tocopherols, and 0.255 percent sterols and having a Lovibond color of 40Y/3.0R, and produced 29 grams of a distillate that contained 61.7 percent free fatty acids, 1.7 percent tocopherols, and 1.9 percent sterols.

### EXAMPLE 3

9.072 kilograms of organic acid refined soybean oil containing 0.3 percent free fatty acids, 0.137 percent tocopherols, and 0.273 percent sterols and having a Lovibond color of 70Y/5.7R was fed at a rate of 10 kg./hr into a deodorizer containing structured packing and operating at an inlet pressure of 1 mm Hg and a temperature of 450° F. Nitrogen was introduced at a rate of 1.2 liters/minute, equating to a rate of 0.836 lbs./100 lbs. oil, or 2.53 standard cubic feet (scf)/100 lbs. oil. The oil was deodorized in the presence of nitrogen for a time of about 90 minutes, producing 9.013 kilograms of deodorized oil (99.4 percent yield) containing 0.053 percent free fatty acids, 0.127 percent tocopherols, and 0.261 percent sterols and having a Lovibond color of 70Y/5.0R, and produced 25 grams of a distillate that contained 70.8 percent free fatty acids, 2.6 percent tocopherols, and 3.9 percent sterols.

### EXAMPLE 4

6.804 kilograms of organic acid refined soybean oil containing 0.3 percent free fatty acids, 0.137 percent tocopherols, and 0.273 percent sterols and having a Lovibond color of 70Y/5.7R was fed at a rate of 10 kg./hr into a deodorizer containing structured packing and operating at an inlet pressure of 1 mm Hg and a temperature of 420° F. Nitrogen was introduced at a rate of 1.2 liters/minute, equating to a rate of 0.836 lbs./100 lbs. oil, or 2.53 standard cubic feet (scf)/100 lbs. oil. The oil was deodorized in the presence of nitrogen for a time of about 90 minutes, producing 6.751 kilograms of deodorized oil (99.2 percent yield) containing 0.137 percent free fatty acids, 0.133 percent tocopherols, and 0.270 percent sterols and having a Lovibond color of 70Y/2.5R, and produced 11.1 grams of a distillate that contained 55.9 percent free fatty acids, 3.6 percent tocopherols, and 5.3 percent sterols.

### EXAMPLE 5

16.0 kilograms of organic acid refined and bleached soybean oil containing 0.38 percent free fatty acids, 0.132 percent tocopherols, and 0.271 percent sterols and was fed at a rate of 10 kg./hr into a deodorizer containing structured packing and operating at an inlet pressure of 1 mm Hg and a temperature of 520° F. Nitrogen was introduced at a rate of 1.2 liters/minute. The oil was deodorized in the presence of nitrogen for a time of about 90 minutes, producing a deodorized oil containing 0.036 percent free fatty acids, 0.107 percent tocopherols, and 0.240 percent sterols.

### EXAMPLE 6

16.0 kilograms of organic acid refined and bleached soybean oil containing 0.38 percent free fatty acids, 0.132 percent tocopherols, and 0.271 percent sterols and was fed at a rate of 10 kg./hr into a deodorizer containing structured packing and operating at an inlet pressure of 1.5 mm Hg and a temperature of 520° F. Nitrogen was introduced at a rate of 1.2 liters/minute. The oil was deodorized in the presence of nitrogen for a time of about 90 minutes, producing a deodorized oil containing 0.03 percent free fatty acids, 0.113 percent tocopherols, and 0.250 percent sterols.

### EXAMPLE 7

16.0 kilograms of organic acid refined and bleached soybean oil containing 0.38 percent free fatty acids, 0.132 percent tocopherols, and 0.271 percent sterols and was fed at a rate of 10 kg./hr into a deodorizer containing structured packing and operating at an inlet pressure of 1.5 m Hg and a temperature of 520° F. Nitrogen was introduced at a rate of 1.5 liters/minute. The oil was deodorized in the presence of nitrogen for a time of about 90 minutes, producing a deodorized oil containing 0.025 percent free fatty acids, 0.099 percent tocopherols, and 0.229 percent sterols.

### EXAMPLE 8

16.0 kilograms of organic acid refined and bleached soybean oil containing 0.38 percent free fatty acids, 0.132 percent tocopherols, and 0.271 percent sterols and was fed at a rate of 10 kg./hr into a deodorizer containing structured packing and operating at an inlet pressure of 2 mm Hg and a temperature of 520° F. Nitrogen was introduced at a rate of 1.5 liters/minute. The oil was deodorized in the presence of nitrogen for a time of about 90 minutes, producing a deodorized oil containing 0.029 percent free fatty acids, 0.090 percent tocopherols, and 0.218 percent sterols.

### EXAMPLE 9

16.0 kilograms of organic acid refined and bleached soybean oil containing 0.38 percent free fatty acids, 0.132 percent tocopherols, and 0.271 percent sterols and was fed at a rate of 10 kg./hr into a deodorizer containing structured packing and operating at an inlet pressure of 1 mm Hg and a temperature of 480° F. Nitrogen was introduced at a rate of 1.2 liters/minute. The oil was deodorized in the presence of nitrogen for a time of about 90 minutes, producing a deodorized oil containing 0.06 percent free fatty acids, 0.117 percent tocopherols, and 0.258 percent sterols.

### EXAMPLE 10

16.0 kilograms of organic acid refined and bleached soybean oil containing 0.38 percent free fatty acids, 0.132 percent tocopherols, and 0.271 percent sterols and was fed at a rate of 10 kg./hr into a deodorizer containing structured packing and operating at an inlet pressure of 1.5 mm Hg and a temperature of 480° F. Nitrogen was introduced at a rate of 1.2 liters/minute. The oil was deodorized in the presence of nitrogen for a time of about 90 minutes, producing a deodorized oil containing 0.049 percent free fatty acids, 0.116 percent tocopherols, and 0.254 percent sterols.

### EXAMPLE 11

16.0 kilograms of organic acid refined and bleached soybean oil containing 0.38 percent free fatty acids, 0.132 percent tocopherols, and 0.271 percent sterols and was fed at a rate of 10 kg./hr into a deodorizer containing structured packing and operating at an inlet pressure of 2 mm Hg and a temperature of 480° F. Nitrogen was introduced at a rate of 1.5 liters/minute. The oil was deodorized in the presence of nitrogen for a time of about 90 minutes, producing a deodorized oil containing 0.055 percent free fatty acids, 0.123 percent tocopherols, and 0.257 percent sterols.

### EXAMPLE 12

16.0 kilograms of organic acid refined and bleached soybean oil containing 0.38 percent free fatty acids, 0.132 percent tocopherols, and 0.271 percent sterols and was fed at a rate of 10 kg./hr into a deodorizer containing structured packing and operating at an inlet pressure of 3 mm Hg and a temperature of 480° F. Nitrogen was introduced at a rate of 1.5 liters/minute. The oil was deodorized in the presence of nitrogen for a time of about 90 minutes, producing a deodorized oil containing 0.079 percent free fatty acids, 0.126 percent tocopherols, and 0.264 percent sterols.

### EXAMPLE 13

16.0 kilograms of organic acid refined and bleached soybean oil containing 0.38 percent free fatty acids, 0.132 percent tocopherols, and 0.271 percent sterols and was fed at a rate of 10 kg./hr into a deodorizer containing structured packing and operating at an inlet pressure of 1.5 mm Hg and a temperature of 520° F. Nitrogen was introduced at a rate of 1.5 liters/minute. The oil was deodorized in the presence of nitrogen for a time of about 90 minutes, producing a deodorized oil containing 0.01 percent free fatty acids, 0.102 percent tocopherols, and 0.24 percent sterols.

### EXAMPLE 14

16.0 kilograms of organic acid refined and bleached soybean oil containing 0.38 percent free fatty acids, 0.132 percent tocopherols, and 0.271 percent sterols and was fed at a rate of 10 kg./hr into a deodorizer containing structured packing and operating at an inlet pressure of 2.5 mm Hg and a temperature of 520° F. Nitrogen was introduced at a rate of 1.5 liters/minute. The oil was deodorized in the presence of nitrogen for a time of about 90 minutes, producing a deodorized oil containing 0.023 percent free fatty acids, 0.107 percent tocopherols, and 0.248 percent sterols.

### EXAMPLE 15

16.0 kilograms of organic acid refined and bleached soybean oil containing 0.38 percent free fatty acids, 0.132 percent tocopherols, and 0.271 percent sterols and was fed at a rate of 10 kg./hr into a deodorizer containing structured packing and operating at an inlet pressure of 3.5 mm Hg and a temperature of 520° F. Nitrogen was introduced at a rate of 1.5 liters/minute. The oil was deodorized in the presence of nitrogen for a time of about 90 minutes, producing a deodorized oil containing 0.04 percent free fatty acids, 0.116 percent tocopherols, and 0.255 percent sterols.

### EXAMPLE 16

16.0 kilograms of organic acid refined and bleached soybean oil containing 0.38 percent free fatty acids, 0.132 percent tocopherols, and 0.271 percent sterols and was fed at a rate of 10 kg./hr into a deodorizer containing structured packing and operating at an inlet liters/minute. The oil was deodorized in the presence of nitrogen for a time of about 90 minutes, producing a deodorized oil containing 0.02 percent free fatty acids, 0.123 percent tocopherols, and 0.265 percent sterols.

### EXAMPLE 17

16.0 kilograms of organic acid refined and bleached soybean oil containing 0.38 percent free fatty acids, 0.132 percent tocopherols, and 0.271 percent sterols and was fed at a rate of 10 kg./hr into a deodorizer containing structured packing and operating at an inlet pressure of 5.5 mm Hg and a temperature of 450° F. Nitrogen was introduced at a rate of 1.5 liters/minute. The oil was deodorized in the presence of nitrogen for a time of about 90 minutes, producing a deodorized oil containing 0.25 percent free fatty acids, 0.128 percent tocopherols, and 0.258 percent sterols.

### EXAMPLE 18

16.0 kilograms of organic acid refined and bleached soybean oil containing 0.38 percent free fatty acids, 0.132 percent tocopherols, and 0.271 percent sterols and was fed at a rate of 10 kg./hr into a deodorizer containing structured packing and operating at an inlet pressure of 1.5 mm Hg and a temperature of 520° F. Nitrogen was introduced at a rate of 1.5 liters/minute. The oil was deodorized in the presence of nitrogen for a time of about 90 minutes, producing a deodorized oil containing 0.021 percent free fatty acids, 0.117 percent tocopherols, and 0.27 percent sterols.

### EXAMPLE 19

16.0 kilograms of organic acid refined and bleached soybean oil containing 0.38 percent free fatty acids, 0.132 percent tocopherols, and 0.271 percent sterols and was fed at a rate of 10 kg./hr into a deodorizer containing structured packing and operating at an inlet pressure of 2.5 mm Hg and a temperature of 520° F. Nitrogen was introduced at a rate of 1.5 liters/minute. The oil was deodorized in the presence of nitrogen for a time of about 90 minutes, producing a deodorized oil containing 0.023 percent free fatty acids, 0.119 percent tocopherols, and 0.264 percent sterols.

### EXAMPLE 20

15.0 kilograms of organic acid refined and bleached soybean oil containing 0.27 percent free fatty acids, 1514 ppm tocopherols, and 2891 ppm sterols and was fed at a rate of 10 kg./hr into a deodorizer containing structured packing and operating at an inlet pressure of 2.5 mm Hg and a temperature of 520° F. A nitrogen stream composed of 30 percent fresh nitrogen and 70 percent recycled and filtered nitrogen was circulated through the deodorizer at a rate of 1.5 liters/minute. The recycled and filtered nitrogen was produced by passing the vaporized distillate produced from deodorization through an ice filter to produce a condensate, leaving an impure nitrogen stream that was then passed through a Parker-Hannifin coalescent filter and then an activated carbon filter. The oil was deodorized in the presence of nitrogen for a time of about 90 minutes, producing a deodorized oil containing 0.033 percent free fatty acids, 1061 ppm tocopherols, and 2300 ppm sterols.

### EXAMPLE 21

15.0 kilograms of organic acid refined and bleached soybean oil containing 0.27 percent free fatty acids, 1514 ppm tocopherols, and 2891 ppm sterols and was fed at a rate of 10 kg./hr into a deodorizer containing structured packing and operating at an inlet pressure of 1.5 mm Hg and a temperature of 520° F. A nitrogen stream composed of 20 percent fresh nitrogen and 80 percent recycled and filtered nitrogen was circulated through the deodorizer at a rate of 1.5 liters/minute. The recycled and filtered nitrogen was produced by passing the vaporized distillate produced from deodorization through an ice filter to produce a condensate, leaving an impure nitrogen stream that was then passed through a Parker-Hannifin coalescent filter and then an activated carbon filter. The oil was deodorized in the presence of nitrogen for a time of about 34 minutes, producing a deodorized oil containing 0.035 percent free fatty acids, 976 ppm tocopherols, and 2115 ppm sterols.

### EXAMPLE 22

15.0 kilograms of organic acid refined and bleached soybean oil containing 0.27 percent free fatty acids, 1514 ppm tocopherols, and 2891 ppm sterols and was fed at a rate of 10 kg./hr into a deodorizer containing structured packing and operating at an inlet pressure of 2.5 mm Hg and a temperature of 520° F. A nitrogen stream composed of 20 percent fresh nitrogen and 80 percent recycled and filtered nitrogen was circulated through the deodorizer at a rate of 1.5 liters/minute. The recycled and filtered nitrogen was produced by passing the vaporized distillate produced from deodorization through an ice filter to produce a condensate, leaving an impure nitrogen stream that was then passed through a Parker-Hannifin coalescent filter and then an activated carbon filter. The oil was deodorized in the presence of nitrogen for a time of about 90 minutes, producing a deodorized oil containing 0.035 percent free fatty acids, 960 ppm tocopherols, and 2167 ppm sterols.

### EXAMPLE 23

15.0 kilograms of organic acid refined and bleached soybean oil containing 0.27 percent free fatty acids, 1514 ppm tocopherols, and 2891 ppm sterols and was fed at a rate of 10 kg./hr into a deodorizer containing structured packing and operating at an inlet pressure of 3.5 mm Hg and a temperature of 520° F. A nitrogen stream composed of 20 percent fresh nitrogen and 80 percent recycled and filtered nitrogen was circulated through the deodorizer at a rate of 1.5 liters/minute. The recycled and filtered nitrogen was produced by passing the vaporized distillate produced from deodorization through an ice filter to produce a condensate, leaving an impure nitrogen stream that was then passed through a Parker-Hannifin coalescent filter and then an activated carbon filter. The oil was deodorized in the presence of nitrogen for a time of about 90 minutes, producing a deodorized oil containing 0.03 percent free fatty acids, 981 ppm tocopherols, and 2206 ppm sterols.

### EXAMPLE 24

15.0 kilograms of organic acid refined and bleached soybean oil containing 0.27 percent free fatty acids, 1514 ppm tocopherols, and 2891 ppm sterols and was fed at a rate of 10 kg./hr into a deodorizer containing structured packing and operating at an inlet pressure of 1.5 mm Hg and a temperature of 520° F. A nitrogen stream composed of 10 percent fresh nitrogen and 90 percent recycled and filtered nitrogen was circulated through the deodorizer at a rate of 1.5 liters/minute. The recycled and filtered nitrogen was produced by passing the vaporized distillate produced from deodorization through an ice filter to produce a condensate, leaving an impure nitrogen stream that was then passed through a Parker-Hannifin coalescent filter and then an activated carbon filter. The oil was deodorized in the presence of nitrogen for a time of about 90 minutes, producing a deodorized oil containing 0.05 percent free fatty acids, 1033 ppm tocopherols, and 2214 ppm sterols.

### EXAMPLE 25

15.0 kilograms of organic acid refined and bleached soybean oil containing 0.27 percent free fatty acids, 1514 ppm tocopherols, and 2891 ppm sterols and was fed at a rate of 10 kg./hr into a deodorizer containing structured packing and operating at an inlet pressure of 2.5 mm Hg and a temperature of 520° F. A nitrogen stream composed of 10 percent fresh nitrogen and 90 percent recycled and filtered nitrogen was circulated through the deodorizer at a rate of 1.5 liters/minute. The recycled and filtered nitrogen was produced by passing the vaporized distillate produced from deodorization through an ice filter to produce a condensate, leaving an impure nitrogen stream that was then passed through a Parker-Hannifin coalescent filter and then an activated carbon filter. The oil was deodorized in the presence of nitrogen for a time of about 90 minutes, producing a deodorized oil containing 0.045 percent free fatty acids, 992 ppm tocopherols, and 2221 ppm sterols.

### EXAMPLE 26

15.0 kilograms of organic acid refined and bleached soybean oil containing 0.27 percent free fatty acids, 1514 ppm tocopherols, and 2891 ppm sterols and was fed at a rate of 10 kg./hr into a deodorizer containing structured packing and operating at an inlet pressure of 3.5 mm Hg and a temperature of 520° F. A nitrogen stream composed of 10 percent fresh nitrogen and 90 percent recycled and filtered nitrogen was circulated through the deodorizer at a rate of 1.5 liters/minute. The recycled and filtered nitrogen was produced by passing the vaporized distillate produced from deodorization through an ice filter to produce a condensate, leaving an impure nitrogen stream that was then passed through a Parker-Hannifin coalescent filter and then an activated carbon filter. The oil was deodorized in the presence of nitrogen for a time of about 90 minutes, producing a deodorized oil containing 0.04 percent free fatty acids, 1008 ppm tocopherols, and 2227 ppm sterols.

### EXAMPLE 27

15.0 kilograms of organic acid refined and bleached soybean oil containing 0.27 percent free fatty acids, 1514 ppm tocopherols, and 2891 ppm sterols and was fed at a rate of 10 kg./hr into a deodorizer containing structured packing and operating at an inlet pressure of 1.5 mm Hg and a temperature of 520° F. A nitrogen stream composed of 5 percent fresh nitrogen and 95 percent recycled and filtered nitrogen was circulated through the deodorizer at a rate of 1.5 liters/minute. The recycled and filtered nitrogen was produced by passing the vaporized distillate produced from deodorization through an ice filter to produce a condensate, leaving an impure nitrogen stream that was then passed through a Parker-Hannifin coalescent filter and then an activated carbon filter. The oil was deodorized in the presence of nitrogen for a time of about 90 minutes, producing a deodorized oil containing 0.04 percent free fatty acids, 956 ppm tocopherols, and 2193 ppm sterols.

### EXAMPLE 28

15.0 kilograms of organic acid refined and bleached soybean oil containing 0.27 percent free fatty acids, 1514 ppm tocopherols, and 2891 ppm sterols and was fed at a rate of 10 kg./hr into a deodorizer containing structured packing and operating at an inlet pressure of 2.5 mm Hg and a temperature of 520° F. A nitrogen stream composed of 5 percent fresh nitrogen and 95 percent recycled and filtered nitrogen was circulated through the deodorizer at a rate of 1.5 liters/minute. The recycled and filtered nitrogen was produced by passing the vaporized distillate produced from deodorization through an ice filter to produce a condensate, leaving an impure nitrogen stream that was then passed through a Parker-Hannifin coalescent filter and then an activated carbon filter. The oil was deodorized in the presence of nitrogen for a time of about 90 minutes, producing a deodorized oil containing 5 0.045 percent free fatty acids, 979 ppm tocopherols, and 2190 ppm sterols.

### EXAMPLE 29

15.0 kilograms of organic acid refined and bleached soybean oil containing 0.27 percent free fatty acids, 1514 ppm tocopherols, and 2891 ppm sterols and was fed at a rate of 10 kg./hr into a deodorizer containing structured packing and operating at an inlet pressure of 3.5 mm Hg and a temperature of 520° F. A nitrogen stream composed of 5 percent fresh nitrogen and 95 percent recycled and filtered nitrogen was circulated through the deodorizer at a rate of 1.5 liters/minute. The recycled and filtered nitrogen was produced by passing the vaporized distillate produced from deodorization through an ice filter to produce a condensate, leaving an impure nitrogen stream that was then passed through a Parker-Hannifin coalescent filter and then an activated carbon filter. The oil was deodorized in the presence of nitrogen for a time of about 90 minutes, producing a deodorized oil containing 0.035 percent free fatty acids, 1013 ppm tocopherols, and 2209 ppm sterols.

### EXAMPLE 30

15.0 kilograms of organic acid refined and bleached soybean oil containing 0.27 percent free fatty acids, 1514 ppm tocopherols, and 2891 ppm sterols and was fed at a rate of 10 kg./hr into a deodorizer containing structured packing and operating at an inlet pressure of 2.5 mm Hg and a temperature of 520° F. A nitrogen stream composed of 20 percent fresh nitrogen and 80 percent recycled and filtered nitrogen was circulated through the deodorizer at a rate of 1.5 liters/minute. The recycled and filtered nitrogen was produced by passing the vaporized distillate produced from deodorization through an ice filter to produce a condensate, leaving an impure nitrogen stream that was then passed through a Parker-Hannifin coalescent filter and then an activated carbon filter. The oil was deodorized in the presence of nitrogen for a time of about 90 minutes, producing a deodorized oil containing 0.05 percent free fatty acids, 1016 ppm tocopherols, and 2223 ppm sterols.

### EXAMPLE 31

15.0 kilograms of organic acid refined and bleached soybean oil containing 0.27 percent free fatty acids, 1514 ppm tocopherols, and 2891 ppm sterols and was fed at a rate of 10 kg./hr into a deodorizer containing structured packing and operating at an inlet pressure of 2.5 mm Hg and a temperature of 520° F. A nitrogen stream composed of 10 percent fresh nitrogen and 90 percent recycled and filtered nitrogen was circulated through the deodorizer at a rate of 1.5 liters/minute. The recycled and filtered nitrogen was produced by passing the vaporized distillate produced from deodorization through an ice filter to produce a condensate, leaving an impure nitrogen stream that was then passed through a Parker-Hannifin coalescent filter and then an activated carbon filter. The oil was deodorized in the presence of nitrogen for a time of about 90 minutes, producing a deodorized oil containing 0.035 percent free fatty acids, 1035 ppm tocopherols, and 2295 ppm sterols.

### EXAMPLE 32

15.0 kilograms of organic acid refined and bleached soybean oil containing 0.27 percent free fatty acids, 1514 ppm tocopherols, and 2891 ppm sterols and was fed at a rate of 10 kg./hr into a deodorizer containing structured packing and operating at an inlet pressure of 2.5 mm Hg and a temperature of 520° F. A nitrogen stream composed of 100 percent recycled and filtered nitrogen was circulated through the deodorizer at a rate of 1.5 liters/minute. The recycled and filtered nitrogen was produced by passing the vaporized distillate produced from deodorization through an ice filter to produce a condensate, leaving an impure nitrogen stream that was then passed through a Parker-Hannifin coalescent filter and then an activated carbon filter. The oil was deodorized in the presence of nitrogen for a time of about 90 minutes, producing a deodorized oil containing 0.044 percent free fatty acids, 1013 ppm tocopherols, and 2245 ppm sterols.

The invention and the manner and process of making and using it, are now described in such full, clear, concise and exact terms as to enable any person skilled in the art to which it pertains, to make and use the same. Although the foregoing describes preferred embodiments of the present invention, modifications may be made therein without departing from the spirit or scope of the present invention as set forth in the claims. To particularly point out and distinctly claim the subject matter regarded as invention, the following claims conclude this specification.

What we claim is:

1. A process for treating edible oil, comprising:
(a) introducing edible oil containing objectionable impurities into a heating zone operating at a pressure of less than about 10 mm Hg and at a temperature of greater than about 375° C.;
(b) deodorizing the edible oil in the presence of non-condensible inert gas for a time sufficient to produce a vapor phase comprising a substantial fraction of the objectionable impurities, other vaporized components of the edible oil, and non-condensible inert gas, leaving a deodorized edible oil;
(c) recovering the non-condensible inert gas from the vapor phase; and
(d) recycling the recovered non-condensible inert gas for use in deodorizing step (b);
wherein a non-steam vacuum source is in communication with and maintains the operating pressure of the heating zone.

2. The process according to claim 1, wherein step (c) recovering occurs by
(a) introducing the vapor phase into one or more cooling zones for a time sufficient to produce one or more condensates, leaving an impure non-condensible inert gas; and
(b) filtering the impure non-condensible inert gas to produce a recovered non-condensible inert gas.

3. A process for treating edible oil, comprising:
(a) introducing edible oil containing objectionable impurities into a first heating zone operating at a pressure of less than about 10 mm Hg and at a first temperature of greater than about 375° F.;
(b) deodorizing the edible oil in the presence of non-condensible inert gas for a time sufficient to produce a first vapor phase comprising a substantial fraction of the objectionable impurities, other vaporized components of the edible oil, and non-condensible inert gas, leaving a liquid residue containing a remaining portion of objectionable impurities;
(c) introducing the liquid residue into a second heating zone operating at a pressure of less than about 10 mm Hg and at a second temperature of greater than about 375° F.;
(d) deodorizing the liquid residue in the presence of non-condensible inert gas for a time sufficient to produce a second vapor phase comprising a substantial fraction of the remaining portion of objectionable impurities, other vaporized components of the liquid residue, and non-condensible inert gas, leaving a deodorized edible oil;
(e) recovering the non-condensible inert gas from one or both of the first and second vapor phases; and
(f) recycling the recovered non-condensible inert gas for use in one or both of deodorizing steps (b) and (d);
wherein a non-steam vacuum source is in communication with and maintains the operating pressure of the first and second heating zones.

4. The process according to claim 3, wherein step (e) recovering occurs by
(a) introducing one or both of the first and second vapor phases into one or more cooling zones for a time sufficient to produce one or more condensates, leaving an impure non-condensible inert gas; and
(b) filtering the impure non-condensible inert gas to produce a recovered non-condensible inert gas.

5. The process according to claim 3, wherein the first temperature is greater than about 475° F.

6. The process according to claim 5, wherein the first temperature is from about 480° to about 525° F.

7. The process according to claim 3, wherein the second temperature is from about 425° to about 470° C.

8. The process according to claim 3, wherein step (b) deodorizing occurs for time of less than about 45 minutes.

9. The process according to claim 3, wherein step (d) deodorizing occurs for a time of less than about 45 minutes.

10. The process according to claim 3, wherein the non-condensible inert gas is selected from the group consisting of nitrogen, carbon dioxide, argon, helium, hydrogen, and mixtures thereof.

11. The process according to claim 11, wherein the non-condensible inert gas is nitrogen.

12. The process according to claim 3, wherein the edible oil is preheated prior to being introduced into the first heating zone.

13. The process according to claim 3, wherein the non-condensible inert gas is preheated prior to being introduced into one or both of the first and second heating zones.

14. The process according to claim 3, wherein the non-condensible inert gas is continuously supplied to the first heating zone at a rate of from about 0.1 to about 10 liters per minute.

15. The process according to claim 3, wherein the non-condensible inert gas is continuously supplied to the second heating zone at a rate of from about 0.1 to about 10 liters per minute.

16. The process according to claim 3, wherein the non-condensible inert gas is supplied to the first and second heating zones at a rate of from about 0.5 to about 3 liters per minute.

17. The process according to claim 3, wherein the amount of recycled recovered non-condensible inert gas is at least about 85 percent of the amount of non-condensible inert gas used in deodorizing steps (b) and (d).

18. The process according to claim 3, wherein the non-steam vacuum source is one or more mechanical vacuum pumps.

19. The process according to claim 4, wherein step (b) filtering occurs by passing the impure non-condensible inert gas through one or both of a coalescent filter and a activated carbon filter.

20. The process according to claim 3, wherein step (e) recovering occurs by
(a) introducing one or both of the first and second vapor phases into one or more cooling zones for a time sufficient to produce one or more condensates, leaving an impure non-condensible inert gas; and
(b) purifying the impure non-condensible inert gas to produce a recovered non-condensible inert gas.

21. The process according to claim 20, wherein the non-condensible inert gas is nitrogen.

22. The process according to claim 21, wherein step (b) purifying occurs by introducing the impure nitrogen into a PSA Nitrogen System.

23. The process according to claim 3, wherein the first heating zone and the second heating zone are located within a vessel having at least two heating zones.

24. The process according to claim 23, wherein one or both of the first and second heating zones contain at least one stripping tray.

25. The process according to claim 23, wherein one or both of the first and second heating zones contains one or more packing materials.

26. The process according to claim 25, wherein the packing material comprises a plurality of sawtooth-profile stainless steel plates spaced closely apart and perforated by a plurality of holes.
